(19) United States
(12) Patent Application Publication
(10) Pub. No.: US 2009/0260284 A1
(43) Pub. Date: Oct. 22, 2009

(54) GREEN ROOF TRAY

(76) Inventor: Daniel Barbalho, Atlanta, GA (US)

Correspondence Address: CARLSON, GASKEY & OLDS, P.C., 400 WEST MAPLE ROAD, SUITE 350, BIRMINGHAM, MI, 48009, US

(21) Appl. No.: 12/106,655

(22) Filed: Apr. 21, 2008

(51) Int. Cl. A01G 9/02

(52) U.S. Cl. 47/65.9

(57) ABSTRACT

An improved plant tray, which is particularly suitable for green roof systems, includes a base having a plurality of walls extending upwardly therefrom to define a tray interior. The base includes a plurality of drainage apertures formed therein. A plurality of upwardly open channels are defined in the base, the channels having a bottom surface that is lower than the drainage apertures. A plurality of reservoirs are connected by the channels, the reservoirs each having a bottom surface that is lower than the channels.

### BACKGROUND OF THE INVENTION

The present invention relates generally to trays in which plants are grown, particularly trays for green roofs.

“Green” roofs, in which grass and other plants cover a substantial portion of a roof of a building, are becoming more common. Generally, the roof is covered with a waterproof layer on which are placed a plurality of trays. The trays contain gravel and soil to support grass or other plants. The soil in the trays will absorb a substantial portion of precipitation that will be consumed by the plants. This reduces and slows the flow of water from the roof, which makes it easier to accommodate. The trays include openings through the bottom, so that excess water drains through the trays slowly onto the waterproof layer. The plants on green roofs also can reduce pollution and provide an esthetically pleasing roofing surface.

### SUMMARY OF THE INVENTION

The present invention provides an improved plant tray, which is particularly suitable for green roof systems.

The example tray disclosed herein includes a base having a plurality of walls extending upwardly therefrom to define a tray interior. The base includes a plurality of drainage apertures formed therein. A plurality of upwardly open channels are defined in the base, the channels having a bottom surface that is lower than the drainage apertures. A plurality of reservoirs are connected by the channels, the reservoirs each having a bottom surface that is lower than the channels.

In another feature of the example tray disclosed herein, at least one handle recess is formed in the exterior of one of the walls.

In another feature of the example tray disclosed herein, at least one channel is defined across an underside of the base, such that conduit or wires can be routed under a plurality of adjacent trays.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of an example tray according to the present invention.

FIG. 2 is a bottom perspective view of the tray of FIG. 1.

FIG. 3 is a top view of the tray of FIG. 1.

FIG. 4 is a side view of the tray of FIG. 1.

FIG. 5 is a section view taken along line C-C of FIG. 3.

FIG. 6 is a section view taken along line D-D of FIG. 3.

FIG. 7 is an end view of the tray of FIG. 1.

FIG. 8 is a section view taken along line A-A of FIG. 3.

FIG. 9 is a section view taken along line B-B of FIG. 3.

FIG. 10 is a perspective view of the tray of FIG. 1 connected to a similar tray.

FIG. 11 is a section through a green roof system including the two trays of FIG. 10.

FIG. 12 shows the tray of FIG. 1 with an optional divider being inserted.

FIG. 13 shows the tray and divider of FIG. 12 assembled.

FIG. 14 is a section view through a pair of adjacent, filled trays with the optional dividers.

### DETAILED DESCRIPTION OF THE PREFERRED EMBODIMENT

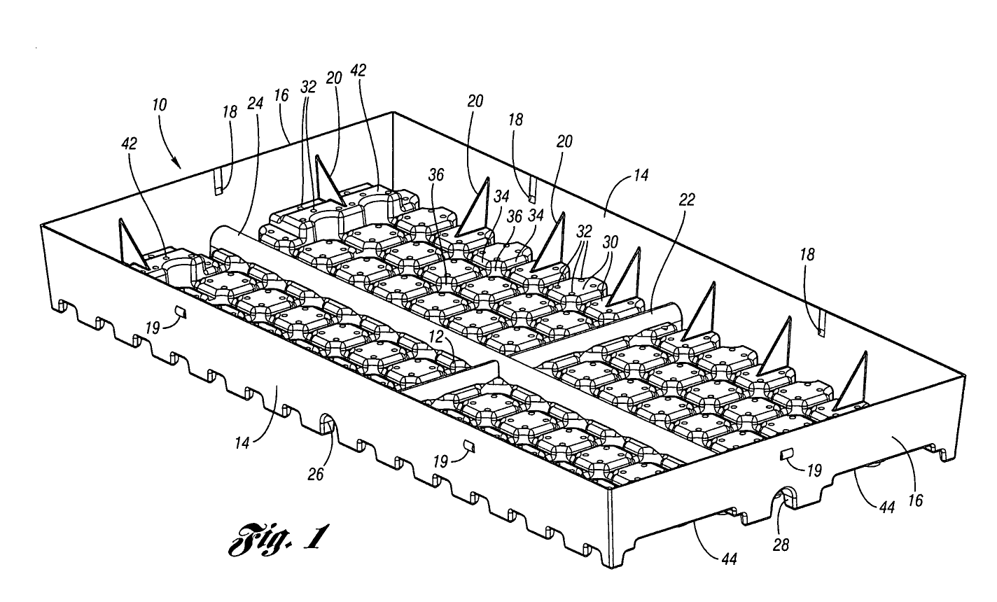

A tray 10 according to one embodiment of the present invention is shown in FIG. 1. The tray 10 includes a base 12 having a pair of opposed side walls 14 and a pair of opposed end walls 16 extending upwardly from a periphery of the base 12. A plurality of connection detents 18 are formed on the interior of the side walls 14 and end walls 16, with corresponding bosses 19 on the exterior of the side walls 14 and end walls 16. A plurality of gussets 20 connect the side walls 14 and end walls 16 to the base 12 to reinforce and stiffen the side walls 14 and end walls 16.

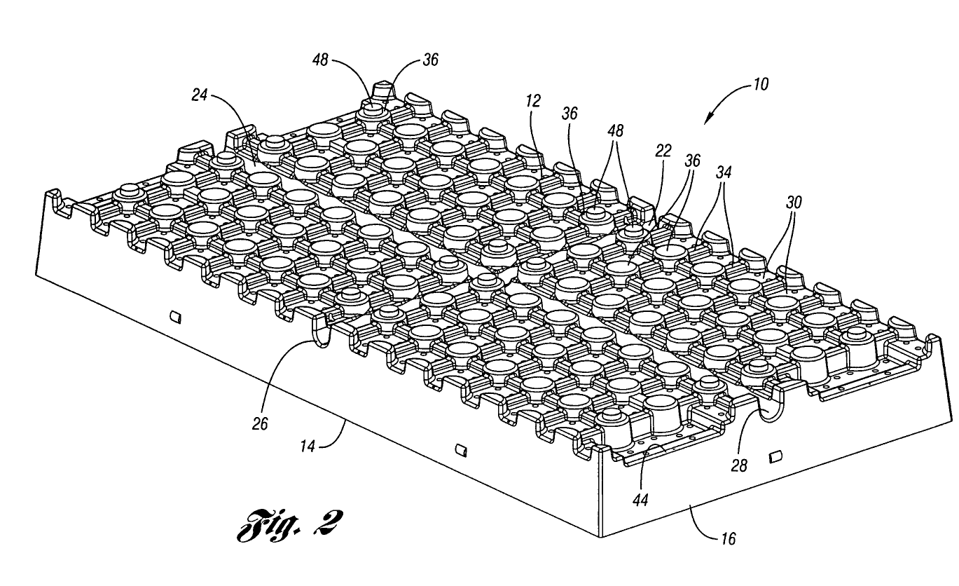

Referring to FIGS. 1 and 2, a lateral channel 22 is defined in the underside of the base 12 completely across the tray 10. The lateral channel 22 extends through the side walls 14 at openings 26. A longitudinal channel 24 is defined in the underside of the base 12 completely across the tray 10. The longitudinal channel 24 extends through the end walls 16 at openings 28.

The base 12 includes a plurality of support surfaces 30 each having a plurality of drainage apertures 32. A plurality of channels 34 are defined between adjacent support surfaces 30. Referring to FIGS. 1 and 2, the channels 34 (specifically, bottom walls of the channels 34) are lower than the support surfaces 30 and drainage apertures 32.

A plurality of cups or reservoirs 36 are fluidly connected by the channels 34. The bottom walls of the reservoirs 36 are lower than the bottom walls of the channels 34, such that water below the level of the channels 34 will remain in the reservoirs 36, water above the level of the channels 34 will flow between reservoirs 36 and water above the channels 34 and above the support surfaces 30 will drain through the drainage apertures 32.

Several end support surfaces 42 adjacent the end walls 16 are at a higher level than the support surfaces 30. The end support surfaces 42 define handle recesses 44 in the exterior of the end walls 16. Optionally, similar handle recesses 44 could be formed in the side walls 14 in addition to, or instead of, the handle recesses 44 in the end walls 16.

Referring to FIG. 2, some of the reservoirs 36 have resilient feet 48 extending downwardly therefrom, held in small holes (not shown) through the reservoirs 36. The resilient feet 48 may be formed of rubber or other resilient material to protect the waterproof layer of a green roof system.

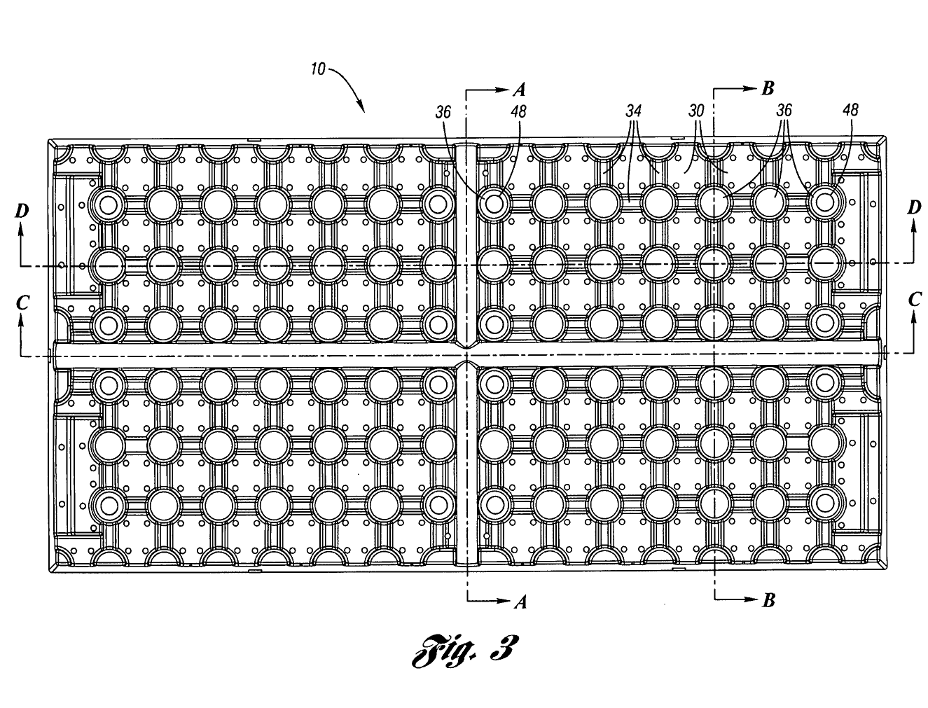

FIG. 3 is a top view of the tray 10. As shown, the support surfaces 30 and channels 34 in the example shown form an array, but other arrangements could be used.

FIG. 4 is a side view of the tray 10. The resilient feet 48 provide the lowermost surfaces of the tray 10, such that the tray 10 rests on the resilient feet 48.

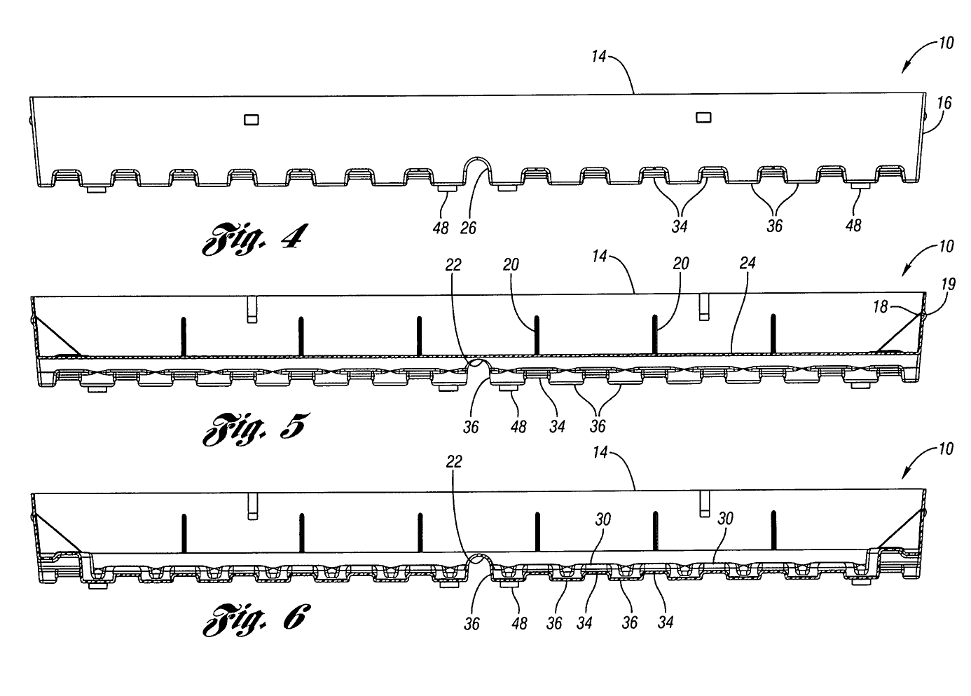

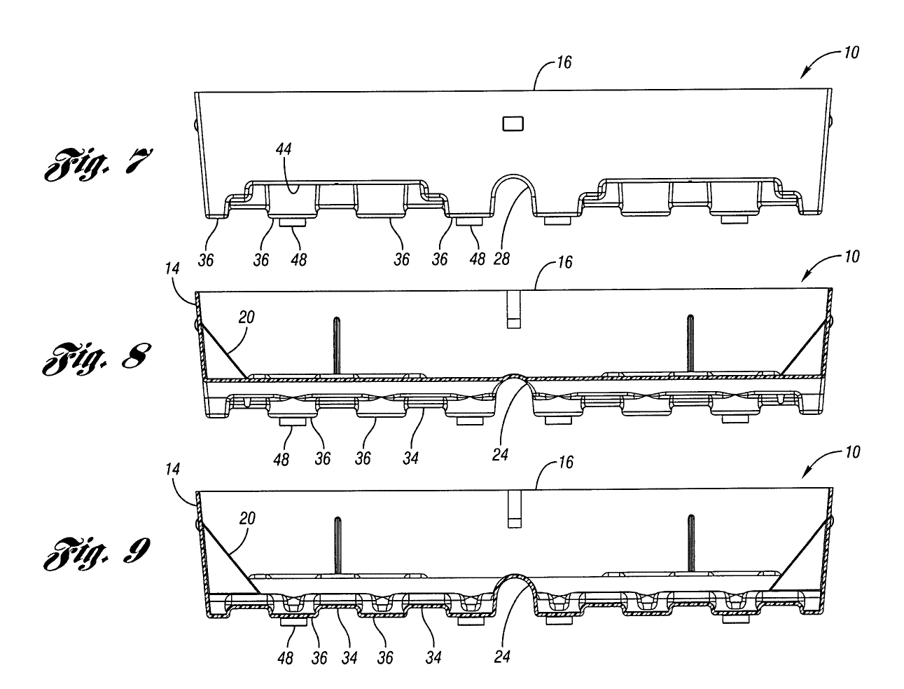

Referring to FIGS. 5 and 6, the support surfaces 30 and apertures 32 (FIG. 1) are formed at a first height of the tray 10. The bottom walls of the channels 34 are formed at a second height of the tray 10, which is less than the first height. The bottom walls of the reservoirs 36 are at a third height of the tray 10, which is less than the first and second heights. The lateral channel opening 26 extends through the side wall 14.

FIG. 7 is an end view of the tray 10 of FIG. 1. The longitudinal channel opening 28 extends through the end wall 16. The handle recesses 44 define recesses at the lower end of the end walls 16 that can be used as handles to lift and carry the tray 10.

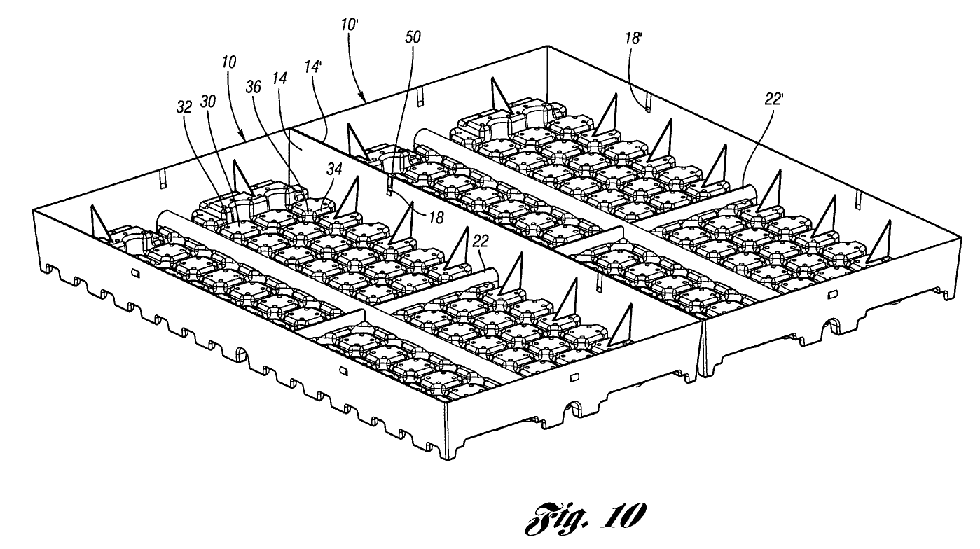

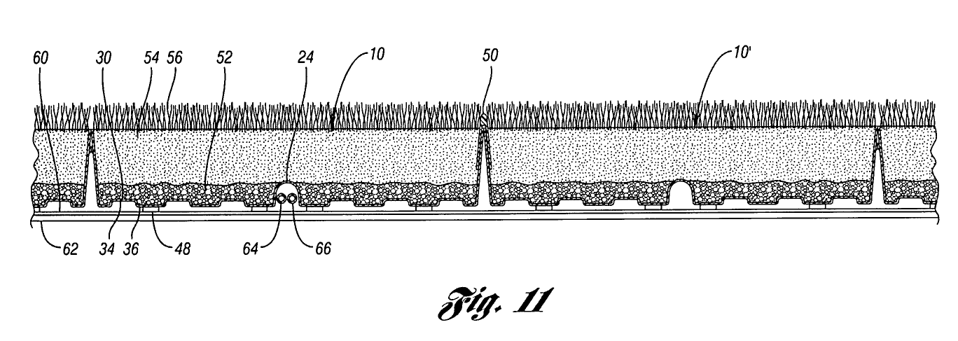

FIG. 8 is a section view taken along line A-A of FIG. 3. FIG. 9 is a section view taken along line B-B of FIG. 3. FIGS. 8 and 9 illustrate the relative heights of the support surfaces 30, channels 34 and reservoirs 36.

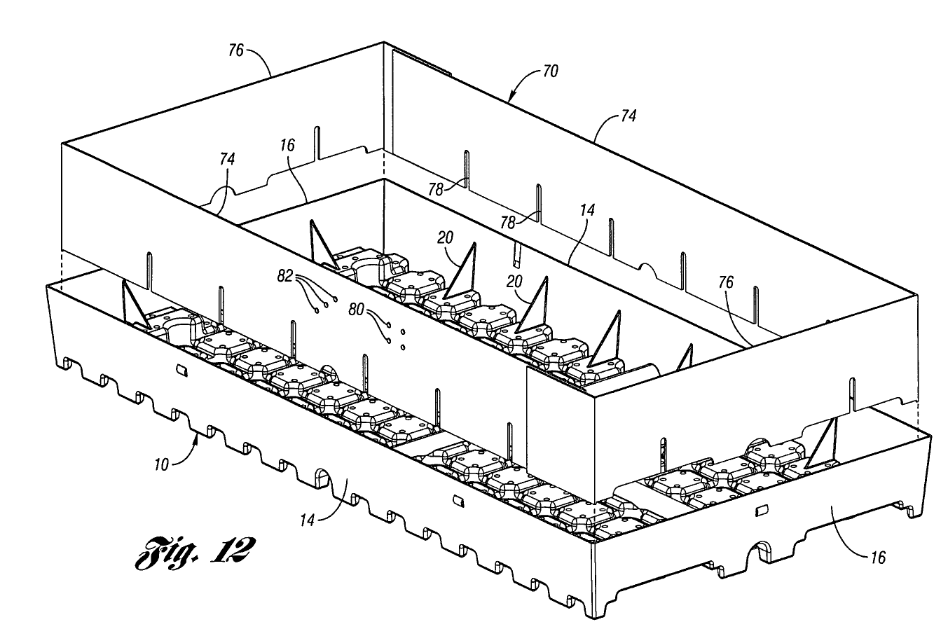

FIG. 10 is a perspective view of the tray 10 connected to a similar tray 10′. A clip 50 is inserted over the adjacent side walls 14, 14′ and is secured by the detents 18, 18′. Clips 50 could also be used to connect adjacent end walls 16 of adjacent trays 10.

FIG. 11 is a section through a green roof system including the two trays 10, 10′. Only two trays 10, 10′ are shown, but it is understood that many trays 10 would be used to cover at least a substantial portion of a roof 62 of a building. In use, the trays 10, 10′ are filled with gravel 52 and soil 54, sand, or other natural or artificial media for supporting plants 56, such as the grass shown in FIG. 11, although other plants could also be supported. The trays 10 are placed on a waterproof surface 60 of the roof 62 and optionally interconnected by the clips 50. Irrigation hoses 64 and/or wiring conduit 66 may be routed under the trays 10, 10′ through the channels.

When it rains, the flow of water is substantially reduced and slowed by the trays 10. Water below the level of the channels 34 will remain in the reservoirs 36 where the roots of the plants may later draw it up. Water above the level of the bottom walls of the channels 34 will flow between reservoirs 36, thus ensuring that the reservoirs 36 are all filled. A long hard rain may result in water levels that are completely above the channels 34. When the water level exceeds the support surfaces 30 the water will drain through the drainage apertures 32 (not visible in FIG. 11; FIG. 1). Thus, the flow of water is reduced and slowed onto the waterproof layer 60 and into storm drains or ponds or other areas where handling the water may be problematic.

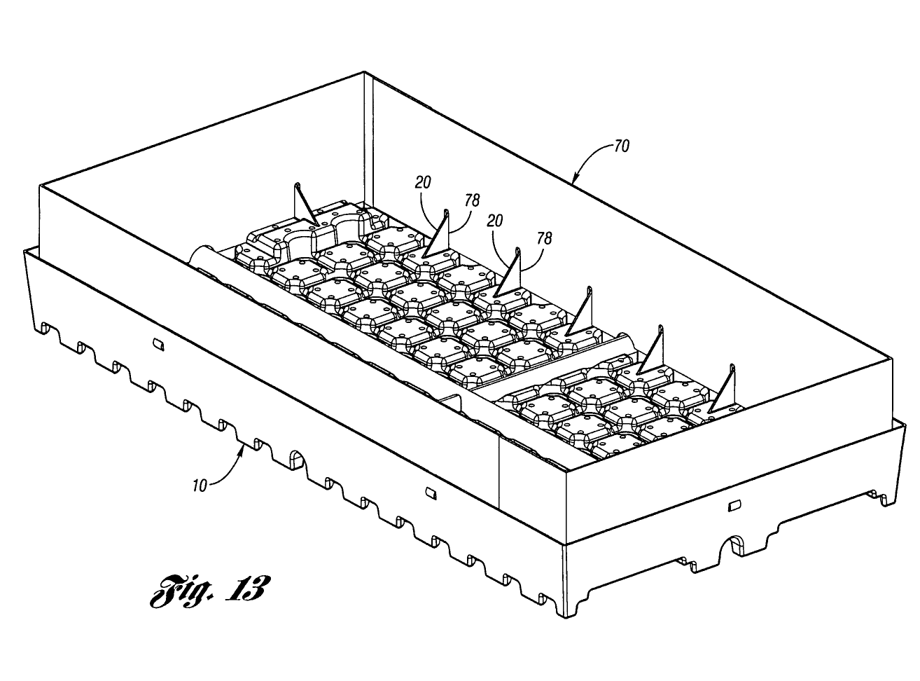

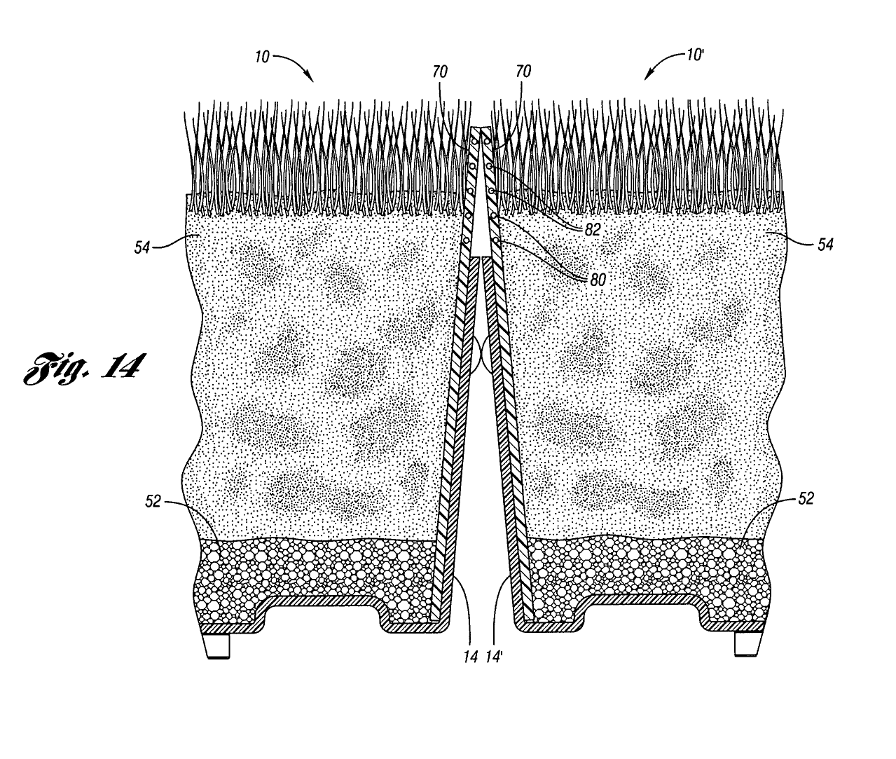

FIG. 12 shows the tray 10 with an optional divider 70 being inserted. The divider 70 includes side walls 74 and end walls 76. The side walls 74 and end walls 76 each include slits 78 for receiving the gussets 20 in the tray 10. The divider 70 is made of a biodegradable material that includes fertilizer 80 and seeds 82 (fertilizer 80 and seeds 82 would be spread evenly throughout the divider 70). The divider 70 is shaped and sized so that it can be received along the interior periphery of the tray 10 as shown in FIG. 13.

Adjacent trays 10, 10′ are shown in section in FIG. 14. With the dividers 70, the trays 10, 10′ can be filled to a level above the uppermost edges of the side walls 14. As a result, when the dividers 70 between adjacent trays 10, 10′ eventually degrade, the soil 54 in the trays 10, 10′ fills in above the walls 14, 14′, thereby providing a more continuous, smooth upper surface to the soil 54 and plants 56. The fertilizer 80 and seeds 82 encourage plant 56 growth in the soil 54 above the adjacent walls 14, 14′, thereby providing a seamless plant surface. The seeds 82 preferably match or complement the plants 56 in the trays 10, 10′.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric labels on method steps are for ease of reference in dependent claims and unless otherwise specified do not require a specific sequence in which the steps are to be performed.

What is claimed is:

1. A tray comprising:
a base; and
a plurality of walls extending upward from the base;
wherein the base includes a plurality of drainage apertures therethrough, the drainage apertures formed at a first height, a plurality of reservoirs formed in the base at a third height, a plurality of channels formed in the base fluidly connecting the plurality of reservoirs at a second height.

2. The tray of claim 1 wherein the first height is greater than the second height.

3. The tray of claim 2 wherein the second height is greater than the third height.

4. The tray of claim 3 further including a plurality of resilient feet extending downward from the base.

5. The tray of claim 4 wherein the plurality of resilient feet extend downward from the reservoirs.

6. The tray of claim 3 further including at least one channel defined in an underside of the base, the channel extending through two of the plurality of walls.

7. The tray of claim 1 further including gussets connecting the base and the walls.

8. The tray of claim 1 wherein at least one of the plurality of walls includes a connection detent for receiving a clip.

9. The tray of claim 8 further including a clip connected to the connection detent.

10. The tray of claim 1 further including a divider along an interior surface of the plurality of walls, the divider including a plurality of seeds.

11. The tray of claim 10 wherein the divider is biodegradable.

12. A tray comprising:
a base; and
a plurality of walls extending upward from the base;
wherein the base includes a plurality of support surfaces having drainage apertures therethrough, a plurality of reservoirs formed in the base, a plurality of channels formed in the base between the support surfaces and fluidly connecting the plurality of reservoirs, wherein bottom walls of the channels are at a height between that of the support surfaces and that of the reservoirs.

13. The tray of claim 12 wherein the support surfaces are arranged in an array.

14. The tray of claim 12 wherein the channels convey liquid between the reservoir at a level below the support surfaces.

15. The tray of claim 12 wherein the channels leave an amount of liquid in the reservoirs below the height of the channels.

16. The tray of claim 12 wherein the drainage apertures through the support surfaces drain liquid at a height above the channels through the base of the tray.

17. The tray of claim 12 further including resilient feet extending from the base downward lower than the reservoirs.

18. The tray of claim 12 further including handle recesses formed in an exterior of the walls.

19. The tray of claim 18 wherein each handle recess defines a corresponding end support surface inside the tray, the end support surfaces having a plurality of apertures therethrough.

20. The tray of claim 12 further including at least one channel defined along an underside of the base and extending through two of the plurality of walls.

21. A green roof system including a plurality of the trays of claim 12.

22. The green roof system of claim 21 wherein each tray supports plants.

23. The green roof system of claim 21 further including connectors connecting adjacent trays.

24. The green roof system of claim 21 further including a waterproof layer on a roof surface, the plurality of trays resting on the waterproof layer.
